(19) United States
(12) Patent Application Publication
(10) Pub. No.: US 2005/0044173 A1
(43) Pub. Date: Feb. 24, 2005

(54) System and method for implementing business processes in a portal

(76) Inventors: Daryl B. Olander, Boulder, CO (US); Richard Feit, Boulder, CO (US); Edward K. O'Neil, Boulder, CO (US); Sathyanarayana Giridhar, Sammamish, WA (US); Jason Howes, Cambridge, MA (US); Douglas Dew, Champaign, IL (US); Thomas A. Cook, Boulder, CO (US); Skip Sauls, Longmont, CO (US); Rodney McCauley, Loveland, CO (US); Michael Blevins, Volcano, CA (US); John Shafer, San Francisco, CA (US); Pal Takacsi-Nagy, Cupertino, CA (US)

Correspondence Address: FLIESLER MEYER, LLP, FOUR EMBARCADERO CENTER, SUITE 400, SAN FRANCISCO, CA, 94111, US

(21) Appl. No.: 10/786,760

(22) Filed: Feb. 25, 2004

Related U.S. Application Data
(60) Provisional application No. 60/451,348, filed on Feb. 28, 2003.

(51) Int. Cl. G06F 15/16

(52) U.S. Cl. 709/217

(57) ABSTRACT

A system and method for a software framework for implementing business processes in a web application, comprising a workflow, a control operable to invoke the workflow, and a page group operable to invoke the control.

### CLAIM OF PRIORITY

This application claims priority from the following application, which is hereby incorporated by reference in its entirety:
SYSTEM AND METHOD FOR IMPLEMENTING BUSINESS PROCESSES IN A PORTAL, U.S. Application No., 60/451,348; Inventors: Daryl Olander et al., filed on Feb. 28, 2003. (Attorney's Docket No. BEAS-1405US0)

### CROSS-REFERENCE TO RELATED APPLICATIONS

This application is related to the following co-pending applications which are each hereby incorporated by reference in their entirety:
OPEN MARKET COLLABORATION SYSTEM FOR ENTERPRISE WIDE ELECTRONIC COMMERCE, U.S. Application No. 60/183,067, Inventors: Rocky Stewart, et al., filed on Feb. 16, 2000. (Attorney's Docket No. BEAS-1033US1)
SYSTEMS AND METHODS UTILIZING A WORKFLOW DEFINITION LANGUAGE, U.S. Application No. 60/450,074, Inventor: Pal Takacsi-Nagy, filed on Feb. 25, 2003. (Attorney's Docket No. BEAS-1389US0)
SYSTEMS AND METHODS FOR CLIENT-SIDE FILTERING OF SUBSCRIBED MESSAGES, U.S. Application No. 60/450,061, Inventors: Mike Blevins, et al., filed on Feb. 25, 2003. (Attorney's Docket No. BEAS-1390US0)
SYSTEM AND METHOD FOR DYNAMIC DATA BINDING IN DISTRIBUTED APPLICATIONS, U.S. Application No. 60/450,516, Inventor: Edward O'Neil, filed on Feb. 26, 2003. (Attorney's Docket No. BEAS-1448US0)
SYSTEMS AND METHODS FOR AN EXTENSIBLE CONTROLS ENVIRONMENT, U.S. Application No. 60/451,352, Inventors: Kyle Marvin, et al., filed on Feb. 28, 2003. (Attorney's Docket No. BEAS-1444US0)
SYSTEM AND METHOD FOR STRUCTURING DISTRIBUTED APPLICATIONS, U.S. Application No. 60/450,226, Inventors: Daryl Olander, et al., filed on Feb. 25, 2003. (Attorney's Docket No. BEAS-1402US0)
REUSABLE SOFTWARE CONTROLS, U.S. Application No. ______, Inventors: Kyle Marvin et al., filed on Feb. 17, 2004. (Attorney's Docket No. BEAS-1354US0)

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present invention disclosure relates to a system and method for implementing business processes in a web portal.

### BACKGROUND

Information technology (IT) systems are often implemented as standalone systems, each addressing particular business issues. Enterprises are faced with the task of integrating these disparate systems. Traditionally, islands of individual applications that needed to share data have been integrated in an ad hoc manner, using homegrown integration. Hard-coded and point-to-point solutions attempt to address the problem but instead can create an IT nightmare of innumerable spaghetti-like connections between applications. These problems are further compounded when trying to surface the functionality of more than one IT system in a single web portal programming paradigm. A development framework is needed to simplify and unify integration of disparate IT systems such that their functionality can be surfaced and interact in the context of a web portal.

### BRIEF DESCRIPTION OF THE DRAWINGS

FIG. 1 is an illustration of exemplary workflows in one embodiment of the invention.

FIG. 2 is an illustration of an exemplary system in an embodiment of the invention.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Many businesses have adopted the concept of workflows to automate business processes. In one embodiment, a workflow generally refers to a software component that is capable of performing a specific set of tasks. These tasks are typically connected in a way that allows them to be ordered upon the completion of the tasks, which can include work items or other workflows. In a workflow, information such as files, documents, or tasks are passed between system resources according to a set of procedural rules so that the system can act upon the information.

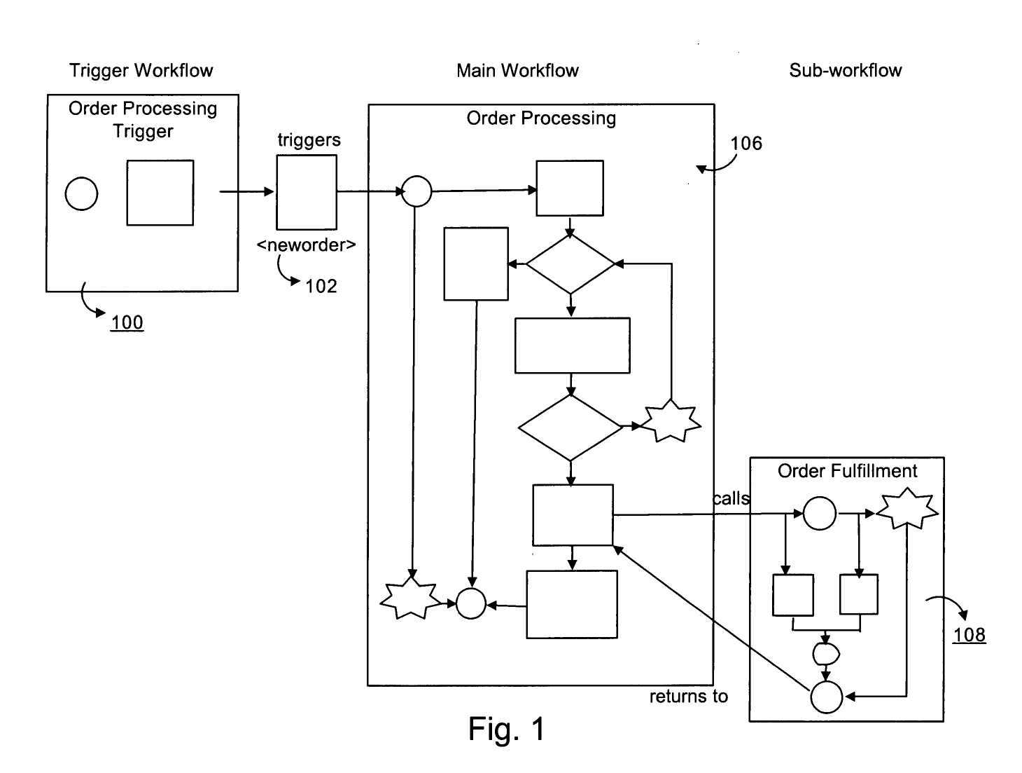

FIG. 1 is an illustration of exemplary workflows in one embodiment of the invention. Trigger workflow 100 sends an order 102 (which is in the form of an XML document) to main workflow 106. The order can contain parameters such as a part number and quantity. The main workflow accepts the order and processes it. Processing of the order might entail determining whether or not a sufficient quantity of the desired part is in stock. Part of the processing requires that the main workflow invoke a subsidiary or sub-workflow 108. Workflows can invoke any number of sub-workflows. Likewise, sub-workflows can invoke other workflows such that invocations of workflows can be nested infinitely. Although not illustrated in FIG. 1, each workflow can execute on the same or different computing device. In addition, a given workflow can be distributed across a plurality of computing devices.

Workflows can be initiated and interacted with via message brokers. A message broker can operate in a server cluster and can allow any server in that cluster to publish to and subscribe to a channel. A server subscribing to a channel can set up a message filter such that XQuery expressions can be used to filter against the messages arriving on the channel. XQuery is a standard query language for processing XML data and data whose structure is similar to XML. A user can write or create an XQuery expression that can extract a portion of the (XML) document payload. The server can then compare the extracted fragment against a filter value for that channel, and if the XML fragment matches the filter value then the server receives the message.

The logic for interaction with message brokers can be encapsulated in one or more controls. Controls can be surfaced in integrated development environments (IDEs). Controls allow a software developer to “plug in” a—sometimes complex—piece of functionality, without the need to understand the details. For example, a developer might drag a graphical representation of a business control off a palette in an IDE and “drop” it onto a graphical canvas wherein it can be connected to other controls or objects in a flow of control. Typically, controls expose one or more interfaces that allow the software developer to access the functionality packaged within the control. Furthermore, controls can communicate with each other, thereby allowing disparate IT workflows to interoperate and exchange information.

Controls can be utilized in portal web pages (or page groups). Page groups include classes that contain user interface control logic. User interface control logic is logic that implements navigation decisions, that flows data into and out of pages and that invokes back-end business logic via calls to controls. Page groups enable developers to simplify the organization of web applications. Developers may use page groups to organize the files of a web application into small, focused units. For example, a developer might organize the files of the human resources portion of a large web application into benefitsWizard, help, hiringWizard, login, payAdjustment Wizard, stockPurchaseWizard and vacationWizard page groups. Page groups are the main part of a web application programming model that enables architects and developers to design and implement web apps using an easy-to-understand, easy-to-maintain, fill-in-the-blanks pattern.

Controls make it easy to access enterprise resources, such as databases, file systems, Enterprise Java Beans, and so on, from within your application. The control handles the work of connecting to the enterprise resource so that programmers can focus on business process logic. When a resource is accessed through a control, the interaction with the resource can be greatly simplified since the underlying control implementation takes care of most of the details. Users need only add an instance of a control to a business process and then invoke its methods. All controls can expose Java interfaces that can be invoked directly from a business process.

Control nodes can be added to a business process to represent points in the business process at which you design interactions with resources via controls. Control Send nodes represent points in business processes at which the business processes send messages to resources via controls. Control Receive nodes represent points in business processes at which the business processes receive asynchronous messages from resources via controls. Business processes can wait at these nodes until they receive a message from the specified control. Control Send with Return nodes can handle synchronous exchange of messages between business process and resources via controls.

Some controls are transactional. This means that the control is able to participate in transactions within a business process. Whether or not a control is transactional depends on both the underlying resource and the specific control implementation. Also, transactional behavior differs depending on whether the control call is synchronous or asynchronous. If the control and associated resource are transactional, the resource participates in the current process transaction. If the control and associated resource are not transactional, changes to the resource occur outside the scope of the current transaction and changes are not rolled back in case of failure.

For asynchronous control calls, the process transaction is not propagated to the resource. Asynchronous control calls are buffered by default. Asynchronous call to the resource are not enqueued until the transaction is committed. On rollback, asynchronous messages are de-queued. A Process control is a special case, since it involves processes calling subprocesses. For synchronous operations the transaction is always propagated to the subprocess. An un-handled exception in a subprocess causes the shared transaction to be marked as rollback only. In this case, both the subprocess and the calling process are rolled back. The subprocess can run in its own transaction.

In one embodiment and by way of example, the following controls are transactional:
Application View (if JCA adapter is transactional)
Message Broker
Process (see the previously listed qualifications)
TPM
WLI JMS
Worklist

By way of example, the following integration controls are not transactional:
File
Email
Service Broker
RosettaNet
ebXML

The system can support custom controls and is flexible, supporting a wide variety of uses for controls. Controls can contain business logic so as to keep it separate from other application code, or which may be reused. Java controls can provide access to resources such as databases or other resources and collect logic that coordinates multiple actions, such as those that involve multiple database queries, calls to Enterprise JavaBeans (with the EJB control), and so on. A control can participate in the implicit transaction of a conversational container, such as a web service that is conversational.

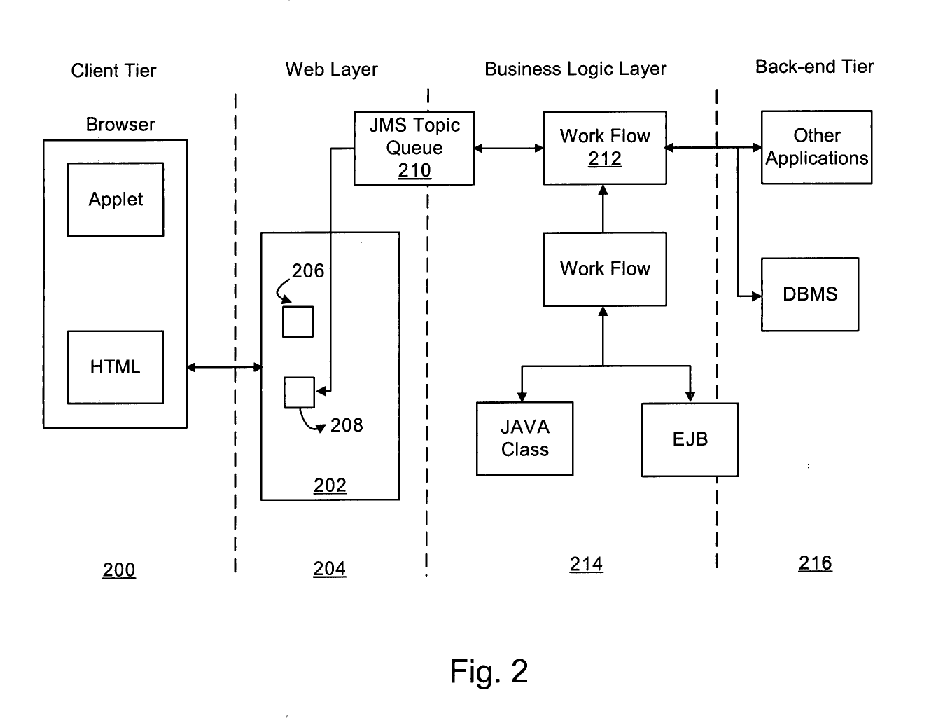

FIG. 2 is an illustration of an exemplary system in an embodiment of the invention. Although this diagram depicts objects/processes as logically separate, such depiction is merely for illustrative purposes. It will be apparent to those skilled in the art that the objects/processes portrayed in this figure can be arbitrarily combined or divided into separate software, firmware and/or hardware components. Furthermore, it will also be apparent to those skilled in the art that such objects/processes, regardless of how they are combined or divided, can execute on the same computing device or can be distributed among different computing devices connected by one or more networks or other suitable communication means.

Referring to FIG. 2, client tier 200 might include a web browser to render HTML and execute Applets. The client tier interacts with a page group 202 in the web layer 204. The page group can include one or more controls (206-208). Control 208 is capable of communicating with message broker 210 in the business logic layer 214 through which it can invoke workflow 212. In one embodiment, a message broker can be a JMS message queue. The workflow in turn may invoke other workflows and/or communicate with the back-end tier 216. Thus, workflows, controls and page groups can be assembled into a powerful, highly leveraged framework for integrating IT systems. Workflows can be accessed through controls. Page groups can integrate controls into a portal and thereby provide a user interface.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. A software framework for implementing business processes in a web application, comprising:
a workflow;
a control operable to invoke the workflow; and
a page group operable to invoke the control.

2. The software framework of claim 1, further comprising:
a message broker operable to enable communication between the control and the workflow.

3. The software framework of claim 1 wherein:
the workflow can invoke another workflow.

4. The software framework of claim 1 wherein:
the page group includes control logic for a graphical user interface.

5. The software framework of claim 1 wherein:
the control exposes functionality through a programmatic interface.

6. The software framework of claim 1 wherein:
the control can communicate with another control.

7. The software framework of claim 1, further comprising:
a web browser; and
wherein the web browser is operable to send a request to the page group.

8. The software framework of claim 1 wherein:
the control is transactional.

9. A method for implementing business processes in a portal, comprising:
providing a workflow;
providing a control operable to invoke the workflow;
providing a page group operable to invoke the control; and

10. The method of claim 9, further comprising:
providing a message broker operable to enable communication between the control and the workflow.

11. The method of claim 9 wherein:
the workflow can invoke another workflow.

12. The method of claim 9 wherein:
the page group includes control logic for a graphical user interface.

13. The method of claim 9 wherein:
the control exposes functionality through a programmatic interface.

14. The method of claim 9 wherein:
the control can communicate with another control.

15. The method of claim 9, further comprising:
providing a web browser; and
wherein the web browser is operable to send a request to the page group.

16. The method of claim 9 wherein:
the control is transactional.

17. A machine readable medium having instructions stored thereon that when executed by a processor cause a system to:
provide a workflow;
provide a control operable to invoke the workflow; and
provide a page group operable to invoke the control.

18. The machine readable medium of claim 17, further comprising instructions that when executed cause the system to:
provide a message broker operable to enable communication between the control and the workflow.

19. The machine readable medium of claim 17 wherein:
the workflow can invoke another workflow.

20. The machine readable medium of claim 17 wherein:
the page group includes control logic for a graphical user interface.

21. The machine readable medium of claim 17 wherein:
the control exposes functionality through a programmatic interface.

22. The machine readable medium of claim 17 wherein:
the control can communicate with another control.

23. The machine readable medium of claim 17, further comprising instructions that when executed cause the system to:
provide a web browser; and
wherein the web browser is operable to send a request to the page group.

24. The machine readable medium of claim 17 wherein:
the control is transactional.

25. A software framework for implementing business processes in a web application, comprising:
a workflow;
a control operable to invoke the workflow;
a page group operable to invoke the control; and
a message broker operable to enable communication between the control and the workflow.

26. The software framework of claim 25 wherein:
the workflow can invoke another workflow.

27. The software framework of claim 25 wherein:
the page group includes control logic for a graphical user interface.

28. The software framework of claim 25 wherein:
the control exposes functionality through a programmatic interface.

29. The software framework of claim 25 wherein:
the control can communicate with another control.

30. The software framework of claim 25, further comprising:
a web browser; and
wherein the web browser is operable to send a request to the page group.

31. The software framework of claim 25 wherein:
the control is transactional.
